(19) United States
(12) Patent Application Publication
(10) Pub. No.: US 2014/0051269 A1
(43) Pub. Date: Feb. 20, 2014

(54) ELECTRONIC DEVICE WITH TWO CIRCUIT BOARDS DEDICATED FOR IC CHIP AND CONNECTOR

(71) Applicant: HON HAI PRECISION INDUSTRY CO., LTD., New Taipei (TW)

(72) Inventors: CHIH-CHUN CHANG, New Taipei (TW); KUO-CHUN HUANG, New Taipei (TW)

(73) Assignee: HON HAI PRECISION INDUSTRY CO., LTD., New Taipei (TW)

(21) Appl. No.: 13/961,887

(22) Filed: Aug. 8, 2013

(30) Foreign Application Priority Data
Aug. 15, 2012 (TW) 101129583

(51) Int. Cl. H01R 12/72

(52) U.S. Cl. CPC H01R 12/722
USPC 439/68

(57) ABSTRACT

An exemplary electronic device with integrated circuit chips being on one circuit board and required connector circuits being on another, connectable, circuit board provides modularization and interchangeability for ease of adaptation in manufacture of electronic products utilizing the electronic device. In particular, the IC chips are mounted on a first circuit board, and the connector circuits are mounted on a second circuit board. The first circuit board is mountable to the second circuit board and is electrically connected to the second circuit board.

### BACKGROUND

1. Technical Field

The disclosed embodiments relate to electronic devices, and particularly, to an electronic device with separated integrated circuit (IC) chips and connectors.

2. Description of Related Art

Numerous electronic products and devices, such as televisions, include a plurality of IC chips and a plurality of connectors. Typically, the IC chips are a demodulator, an audio/video decoder, and the like; and the connectors are a high definition multimedia interface (HDMI) connector, a tuner having an input port for receiving television signals from television cables, an audio connector, a universal serial bus (USB) connector, and the like. In the United States, the television must use an advanced television systems committee (ATSC) demodulator, and a moving picture experts group-2 (MPEG-2) audio/video decoder.

Television manufacturers usually mount the IC chips and the connectors on a same circuit board. That is, the ATSC demodulator, the MPEG-2 audio/video decoder, the USB connector, and the audio connector, etc., are mounted on a same circuit board. Therefore, when the television manufacturer manufactures other types of televisions, the whole circuit board must be reconfigured again. This is inconvenient, time-consuming, and costly.

Therefore, there is room for improvement in the art.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, like reference numerals designate corresponding parts throughout the six views.

FIG. 1 is an exploded view showing an electronic device in accordance with a first embodiment.

FIG. 2 is an assembled view of the electronic device in FIG. 1.

FIG. 3 is an exploded view showing an electronic device in accordance with a second embodiment.

FIG. 4 is an exploded view showing an electronic device in accordance with a third embodiment.

FIG. 5 is an assembled view of the electronic device in FIG. 4.

FIG. 6 is an exploded view showing an electronic device in accordance with a fourth embodiment.

### DETAILED DESCRIPTION

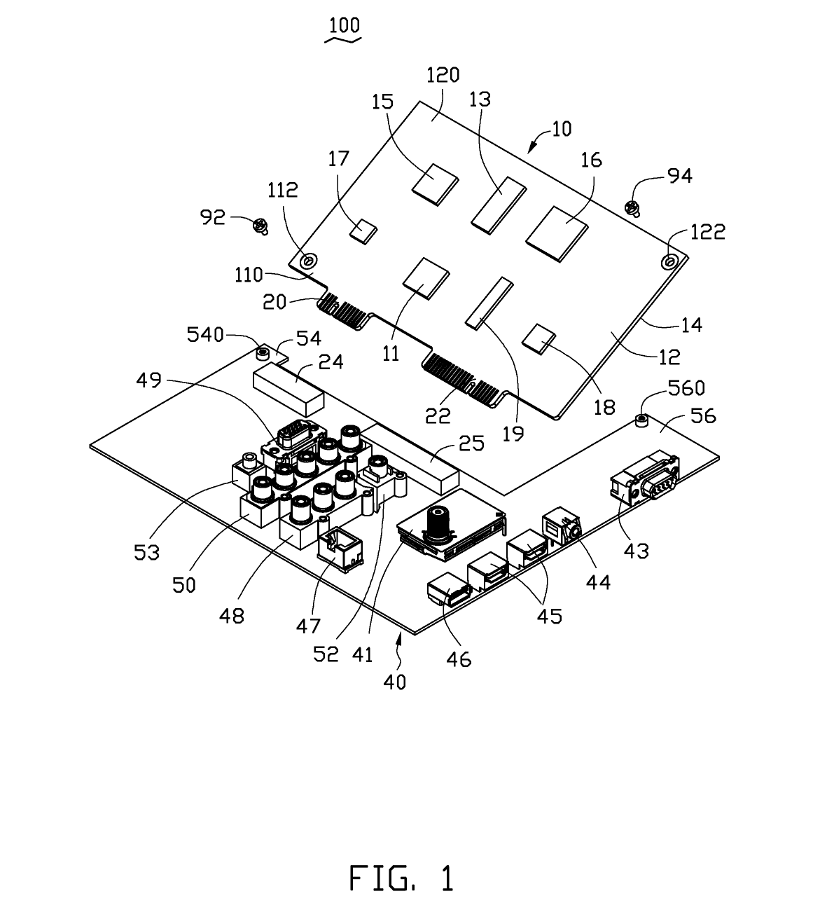

FIG. 1 shows an electronic device 100 in accordance with a first embodiment. The electronic device 100 includes a first circuit board 10, a second circuit board 40, a plurality of integrated circuit (IC) chips, and a plurality of connectors. The electronic device 100 can be part of a television, for example. In other embodiments, there is only a single IC chip, and only a single connector.

The IC chips are mounted on the first circuit board 10. The IC chips include a processor 11, a demodulator 13, an audio/video decoder 15, a wireless module 16, a speaker IC chip 17, an audio amplifier 18, and a memory 19. The demodulator 13 is an ATSC demodulator, for example. The audio/video decoder 15 is an MPEG-2 audio/video decoder, for example. The wireless module 16 is typically a wireless transceiver, which can be a Wireless Fidelity (WIFI) module or a radio communication module (e.g. a Bluetooth module or a ZigBee module), for example. In other embodiments, the IC chips include the demodulator 13 and the audio/video decoder 15 only.

The connectors are mounted on the second circuit board 40. The connectors include a recommended standard-232 (RS-232) connector 43, a tuner 41 having an input port for receiving television broadcasting signals, an earphone connector 44, a high definition multimedia interface (HDMI) connector 45, a universal serial bus (USB) connector 46, a local area network (LAN) connector 47, a composite video blanking sync (CVBS) connector 48, a video graphics array (VGA) connector 49, a luminance and chrominance (YPbPr) connector 50, a Sony/Philips digital interface (SPDIF) connector 52, and an audio connector 53.

The first circuit board 10 is mounted to the second circuit board 40 and is electrically connected to the second circuit board 40.

In detail, the electronic device 100 further includes two first protrusions 20, 22 protruding from a main portion of the first circuit board 10, and two primary female connectors 24, 25 mounted on the second circuit board 40. The first protrusions 20, 22 can for example be card edge connectors, and in the illustrated embodiment are portions of the first circuit board 10. The primary female connectors 24, 25 can for example be slot connectors. In such case, the slots of the primary female connectors 24, 25 are located at lateral sides thereof. A plurality of conductive terminals are disposed on each of the first protrusions 20, 22. In the embodiment, each of the first protrusions 20, 22 with the plurality of conductive terminals is defined as a primary male connector. In other embodiments, only one of the first protrusions 20, 22 is provided, and only one of the primary female connectors 24, 25 is provided.

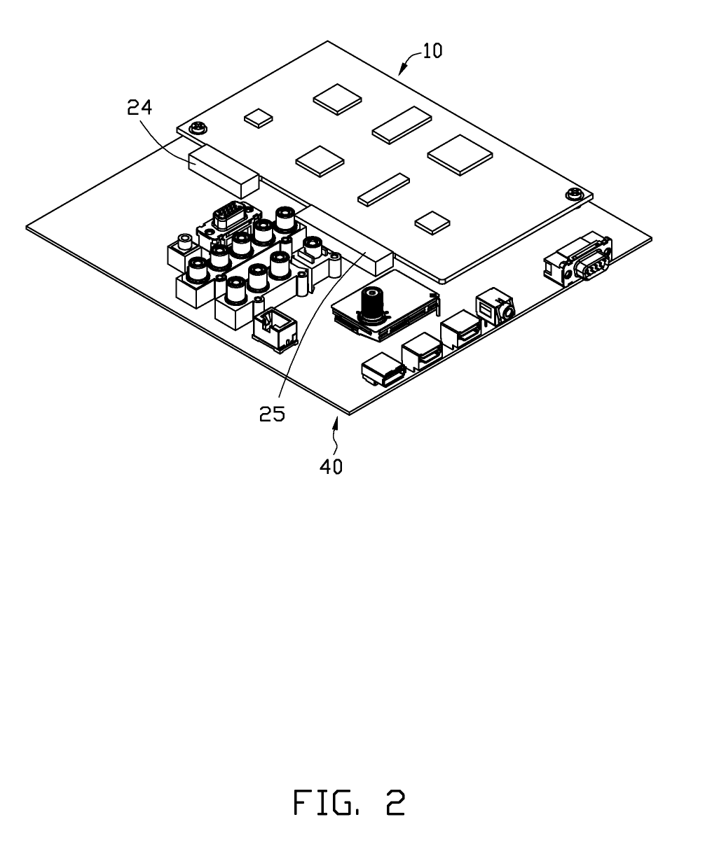

The two first protrusions 20, 22 are engaged with the two primary female connectors 24, 25 respectively as follows. Firstly, the two first protrusions 20, 22 are oriented aslant and partially inserted into the two primary female connectors 24, 25 respectively. Then, the two first protrusions 20, 22 are horizontally and fully inserted into the two primary female connectors 24, 25 respectively, as shown in FIG. 2. After the engagement, the plurality of conductive terminals disposed on the first protrusion 20 are electrically connected to the primary female connector 24, and the plurality of conductive terminals disposed on the first protrusion 22 are electrically connected to the primary female connector 25. Thereby, the plurality of IC chips communicate with the plurality of connectors respectively.

For example, the tuner 41 receives a plurality of television signals through a television cable, selects one of the television signals, and transmits the selected television signal (which is defined as a first signal) to the demodulator 13 through the primary female connector 24 and the first protrusion 20. Then the demodulator 13 demodulates the selected television signal.

In contrast, the wireless module 16 receives an audio signal which is defined as a second signal. The audio amplifier 18 amplifies the audio signal, and transmits the amplified audio signal to the earphone connector 44 through the first protrusion 22 and the primary female connector 25. Then the earphone connector 44 outputs the amplified audio signal to an earphone (not shown), and the earphone outputs the amplified audio signal as sound.

Furthermore, the electronic device 100 also includes a first fixing element 92, a second fixing element 94, a second protrusion 54 and a third protrusion 56. The second protrusion 54 and the third protrusion 56 protrude from a main portion of the second circuit board 40. In the illustrated embodiment, the second and third protrusions 54, 56 are portions of the second circuit board 40. A first fixing part 540 and a second fixing part 560 are disposed on the second protrusion 54 and the third protrusion 56, respectively. The first circuit board 10 defines a first through hole 112 and a second through hole 122. The first fixing element 92 partially passes through the first through hole 112 and is then fixed to the first fixing part 540, and the second fixing element 94 partially passes through the second through hole 122 and is then fixed to the second fixing part 560. In the embodiment, the first fixing element 92 and the second fixing element 94 are screws, and the second protrusion 54 is parallel to the third protrusion 56.

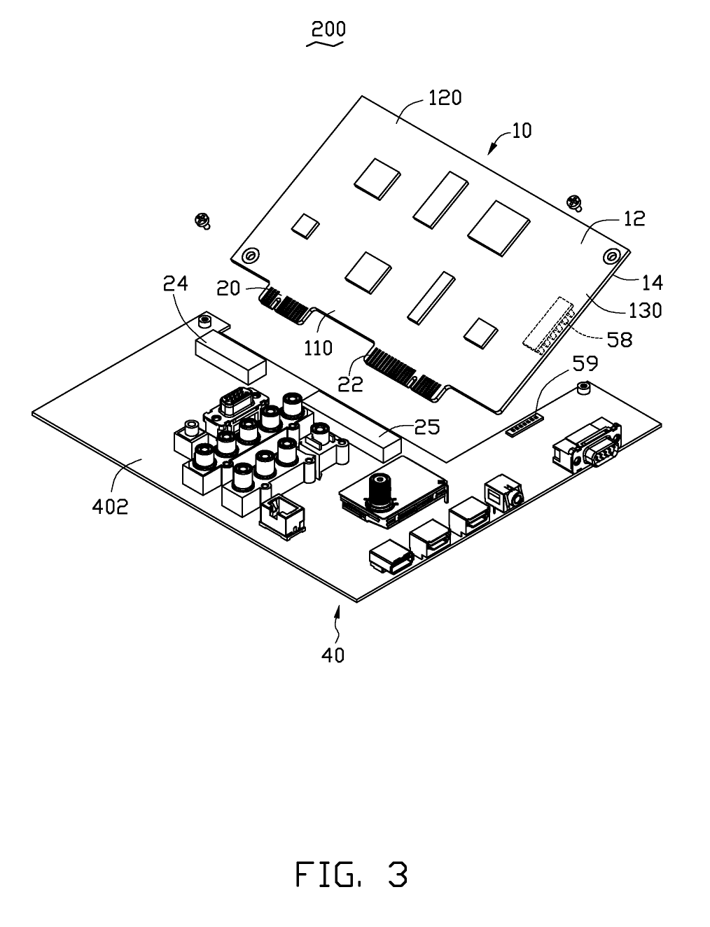

FIG. 3 shows an electronic device 200 in accordance with a second embodiment. The difference between the electronic device 200 of the second embodiment and the electronic device 100 of the first embodiment is that the electronic device 200 further includes a secondary male connector 58 and a secondary female connector 59. The first circuit board 10 includes a first surface 12 and a second surface 14 at opposite sides thereof, and the second circuit board 40 includes a third surface 402. The above-described seven IC chips 11, 13, 15, 16, 17, 18, 19 are mounted on the first surface 12, and the secondary male connector 58 is mounted on the second surface 14. The above-described eleven connectors 41, 43, 44, 45, 46, 47, 48, 49, 50, 52, 53 are mounted on the third surface 402, and the secondary female connector 59 is also mounted on the third surface 402. The secondary male connector 58 couples with the secondary female connector 59, and thereby the first circuit board 10 can communicate with the second circuit board 40 through the secondary male connector 58 and the secondary female connector 59.

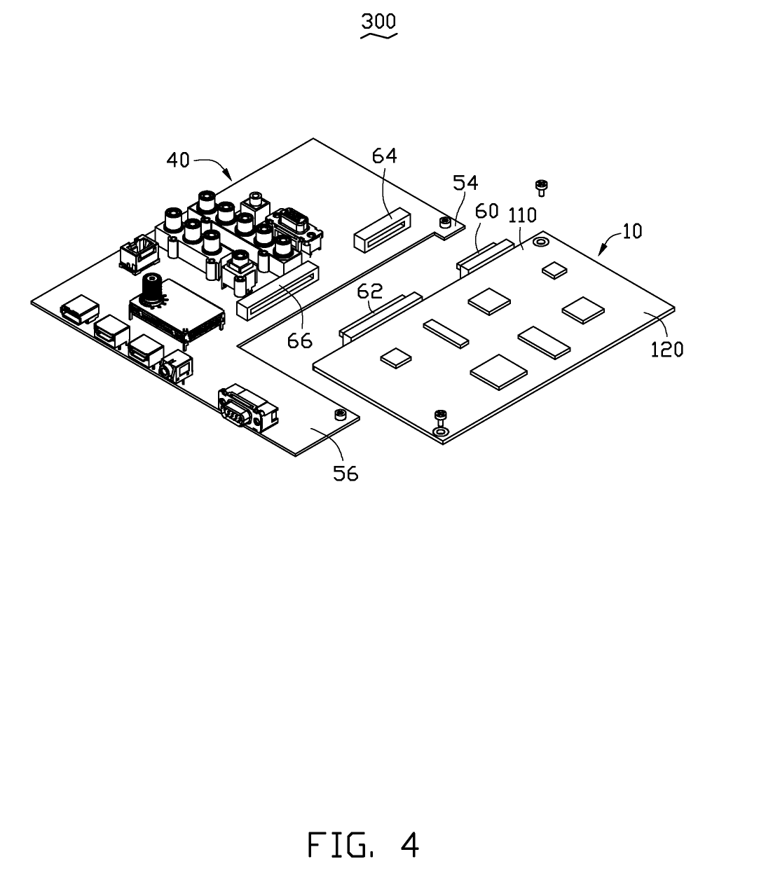

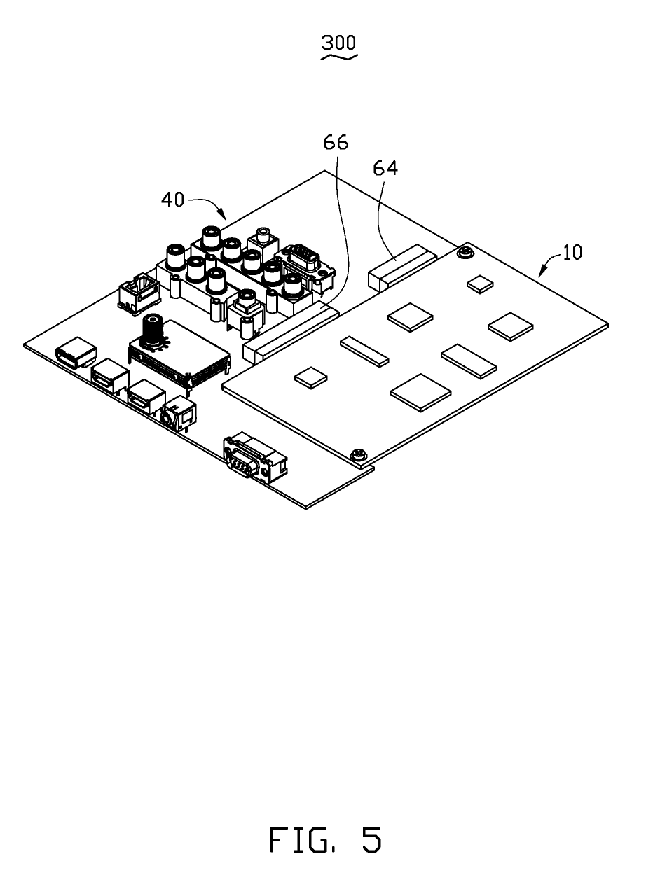

FIG. 4 shows an electronic device 300 in accordance with a third embodiment. The difference between the electronic device 300 of the third embodiment and the electronic device 100 of the first embodiment is that the electronic device 300 includes two first male connectors 60, 62 mounted on one side of the first circuit board 10, and two first female connectors 64, 66 mounted on the second circuit board 40. Slots of the two first female connectors 64, 66 are located at lateral sides of the first female connectors 64, 66. Protrusions of the two first male connectors 60, 62 corresponding to the slots are oriented parallel to the first circuit board 10. The two first male connectors 60, 62 are engaged with the two first female connectors 64, 66 respectively as follows: the two first male connectors 60, 62 are fully and horizontally inserted into the two first female connectors 64, 66 respectively, as shown in FIG. 5. Thereby, the first circuit board 10 can communicate with the second circuit board 40 through the two first male connectors 60, 62 and the two first female connectors 64, 66.

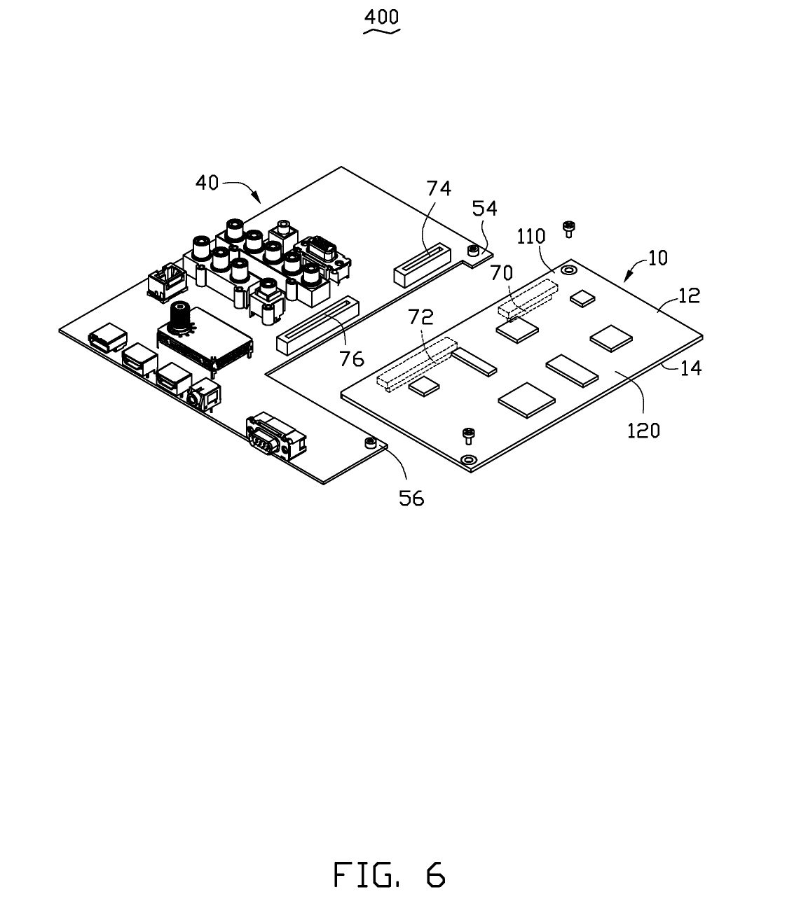

FIG. 6 shows an electronic device 400 in accordance with a fourth embodiment. The difference between the electronic device 400 of the fourth embodiment and the electronic device 100 of the first embodiment is that the electronic device 400 includes two second male connectors 70, 72 and two second female connectors 74, 76. The first circuit board 10 includes the first surface 12 and the second surface 14 at opposite sides thereof. The above-described seven IC chips 11, 13, 15, 16, 17, 18, 19 are mounted on the first surface 12, and the two second male connectors 70, 72 are mounted on the second surface 14. The two second female connectors 74, 76 are mounted on the second circuit board 40. Slots of the two second female connectors 74, 76 are located at top sides of the second female connectors 74, 76. Protrusions of the two second male connectors 70, 72 corresponding to the slots are oriented perpendicular to the first circuit board 10. The two second male connectors 70, 72 are coupled with two second female connectors 74, 76 respectively, as follows: the two second male connectors 70, 72 are fully and vertically inserted into the two second female connectors 74, 76 correspondingly. Thereby, the first circuit board 10 can communicate with the second circuit board 40 through the two second male connectors 70, 72 and the two second female connectors 74, 76.

In the above-described electronic devices 100, 200, 300, 400, the group of seven IC chips 11, 13, 15, 16, 17, 18, 19 and the group of eleven connectors 41, 43, 44, 45, 46, 47, 48, 49, 50, 52, 53 are mounted on different circuit boards. Therefore when a manufacturer manufactures other types of televisions having different connectors, the first circuit board 10 including the ATSC demodulator and the MPEG-2 audio/video decoder can be utilized as is, without any need for reconfiguration. The manufacturer only needs to reconfigure the second circuit board 40. This makes the manufacturing of the other types of televisions convenient, speedy, and cost-effective.

What is claimed is:

1. An electronic device, comprising:
a first circuit board;
a second circuit board;
at least one integrated circuit (IC) chip mounted on the first circuit board; and
at least one connector mounted on the second circuit board;
wherein the first circuit board is mounted to the second circuit board and is electrically connected to the second circuit board.

2. The electronic device of claim 1, further comprising:
at least one male board-to-board connector mounted on the first circuit board; and
at least one female board-to-board connector mounted on the second circuit board;
wherein the at least one male board-to-board connector is electrically connected to the at least one female board-to-board connector.

3. The electronic device of claim 2, wherein the at least one IC chip comprises a wireless module IC chip, a second IC chip and a third IC chip, the at least one connector comprises a first connector and a second connector, the wireless module is configured to receive a first signal and transmit the first signal to the second IC chip, the second IC chip is configured to process the first signal, and transmit the processed first signal to the first connector through one of the at least one male board-to-board connector and one of the at least one female board-to-board connector, and the first connector is configured to output the processed first signal; and the second connector is configured to receive a second signal, and transmit the second signal to the third IC chip through one of the at least one female board-to-board connector and one of the at least one male board-to-board connector, and the third IC chip is configured to process the second signal.

4. The electronic device of claim 3, wherein the wireless module comprises one of a Wireless Fidelity (WIFI) module and a radio communication module.

5. The electronic device of claim 2, wherein the at least one male board-to-board connector comprises two male board-to-board connectors, which comprise two first protrusions protruding from a main portion of the first circuit board, and a plurality of conductive terminals disposed on each of the first protrusions; the at least one female board-to-board connector comprises two primary female connectors each having a slot, with the slots of the primary female connectors located at lateral sides of the primary female connectors; and the plurality of conductive terminals disposed on the first protrusion of each male board-to-board connector are received in the slot of a corresponding one of the primary female connectors and electrically connected to the corresponding one of the primary female connectors.

6. The electronic device of claim 5, wherein the at least one male board-to-board connector further comprises a secondary male board-to-board connector, the at least one female board-to-board connector further comprises a secondary female board-to-board connector; the first circuit board comprises a first surface and a second surface at opposite sides thereof, and the second circuit board comprises a third surface; the at least one IC chip is mounted on the first surface, and the secondary male board-to-board connector is mounted on the second surface; the at least one connector and the secondary female board-to-board connector are mounted on the third surface; and the secondary male board-to-board connector is coupled with the secondary female board-to-board connector.

7. The electronic device of claim 6, further comprising a first fixing element, a second fixing element, a first fixing part, and a second fixing part, wherein a second protrusion and a third protrusion protrude from a main portion of the second circuit board, the first fixing part and the second fixing part are disposed on the second protrusion and the third protrusion, respectively, the secondary female connector is mounted on the third protrusion, the first circuit board defines a first through hole and a second through hole; the first fixing element partially passes through the first through hole and is fixed to the first fixing part, and the second fixing element partially passes through the second through hole and is fixed to the second fixing part.

8. The electronic device of claim 7, wherein the first fixing element and the second fixing element are screws, and the second protrusion is parallel to the third protrusion.

9. The electronic device of claim 2, wherein the at least one male board-to-board connector comprises two male board-to-board connectors mounted on one side of the first circuit board, the at least one female board-to-board connector comprises two female board-to-board connectors each having a slot, the slots of the two female board-to-board connectors are located at lateral sides of the two female board-to-board connectors, protrusions of the two male board-to-board connectors corresponding to the slots are oriented parallel to the first circuit board, and the protrusions of the two male board-to-board connectors are received in the slots of the two female board-to-board connectors such that the two male board-to-board connectors are coupled with the two female board-to-board connectors, respectively.

10. The electronic device of claim 9, further comprising a first fixing element, a second fixing element, a first fixing part, and a second fixing part, wherein a second protrusion and a third protrusion protrude from the second circuit board, the first fixing part and the second fixing part are disposed on the second protrusion and the third protrusion, respectively, the first circuit board defines a first through hole and a second through hole, the first fixing element partially passes through the first through hole and is fixed to the first fixing part, and the second fixing element partially passes through the second through hole and is fixed to the second fixing part.

11. The electronic device of claim 2, wherein the at least one male board-to-board connector comprises two male board-to-board connectors, the at least one female connector comprises two female board-to-board connectors each having a slot, the first circuit board comprises a first surface and a second surface at opposite sides thereof, the at least one IC chip is mounted on the first surface, the two male board-to-board connectors are mounted on the second surface, the slots of the two female board-to-board connectors are located at top sides of the female board-to-board connectors, protrusions of the two male connectors corresponding to the slots are oriented perpendicular to the first circuit board, and the protrusions of the two male board-to-board connectors are received in the slots of the two female board-to-board connectors such that the two male board-to-board connectors are coupled with two female board-to-board connectors, respectively.

12. The electronic device of claim 11, further comprising a first fixing element, a second fixing element, a first fixing part, and a second fixing part, wherein a second protrusion and a third protrusion protrude from the second circuit board, the first fixing part and the second fixing part are disposed on the second protrusion and the third protrusion, respectively, the first circuit board defines a first through hole and a second through hole, the first fixing element partially passes through the first through hole and is fixed to the first fixing part, and the second fixing element partially passes through the second through hole and is fixed to the second fixing part.

13. The electronic device of claim 1, wherein the at least one IC chip is a plurality of IC chips, which are selected from the group consisting of a processor, a demodulator, an audio/video decoder, and an audio amplifier; and the at least one connector is a plurality of connectors, which are selected from the group consisting of a high definition multimedia interface (HDMI) connector, a tuner having an input port for receiving television broadcasting signals, a universal serial bus (USB) connector, a digital interface connector, a local area network (LAN) connector, a video graphics array (VGA) connector, an audio connector, a luminance and chrominance (YPbPr) connector, a composite video blanking sync (CVBS) connector, a recommended standard-232 (RS-232) connector, and an earphone connector.

14. The electronic device of claim 13, wherein the group from which the plurality of IC chips are selected further consists of a speaker IC chip and a memory.

15. An electronic device, comprising:
a first circuit board;
a second circuit board;
at least one integrated circuit (IC) chip mounted on the first circuit board;
at least one connector mounted on the second circuit board;
at least one male board-to-board connector mounted on the first circuit board; and
at least one female board-to-board connector mounted on the second circuit board;
wherein the at least one male board-to-board connector is electrically connected to the at least one female board-to-board connector.

16. The electronic device of claim 15, further comprising: a wireless module configured to receive a first signal and transmit the first signal to the at least one IC chip;
wherein the at least one IC chip is configured to process the first signal, and transmit the processed first signal to the at least one connector through the at least one female connector and the at least one male connector, the at least one connector is configured to output the processed first signal; and
wherein the at least one connector is configured to receive a second signal, and transmit the second signal to the at least one IC chip through the at least one male connector and the at least one female connector, the at least one IC chip is configured to process the second signal.

17. The electronic device of claim 15, wherein the at least one male connector comprises two first protrusions protruding from a main portion of the second circuit board; a plurality of conductive terminals are disposed on each of the first protrusions;
the at least one female connector comprises two primary female connectors, the slots of the primary female connectors are located at lateral sides thereof; and the plurality of conductive terminals disposed on each of the first protrusions are electrically connected to the corresponding one of the primary female connectors.

18. The electronic device of claim 16, wherein the wireless module comprises one of a Wireless Fidelity (WIFI) module and a radio communication module.
